(19) United States
(12) Patent Application Publication
(10) Pub. No.: US 2019/0159111 A1
(43) Pub. Date: May 23, 2019

(54) Method for Wireless Fidelity Network Scanning and Terminal Device

(71) Applicant: Guangdong Oppo Mobile Telecommunications Corp., Ltd., Dongguan (CN)

(72) Inventor: Yi Yu, Dongguan (CN)

(21) Appl. No.: 16/253,619

(22) Filed: Jan. 22, 2019

Related U.S. Application Data
(63) Continuation of application No. PCT/CN2017/101466, filed on Sep. 12, 2017.

(30) Foreign Application Priority Data
Dec. 7, 2016 (CN) 201611143072.7

(51) Int. Cl. H04W 48/16; H04W 48/20; H04W 12/06

(52) U.S. Cl. CPC H04W 48/16; H04W 84/12; H04W 12/0608; H04W 48/20

(57) ABSTRACT

A method for wireless fidelity (Wi-Fi) network scanning and a terminal device are provided. The method includes the following. After a terminal device is disconnected from a Wi-Fi network, it is determined whether a beacon frame is received from an access point. When the beacon frame is received, Wi-Fi network scanning is executed, for example, Wi-Fi network scanning is executed according to information of the access point, or according to information of multiple stable access points. After the access point is scanned, the terminal device may be connected to the access point automatically if the terminal device was previously connected to the access point.

### CROSS-REFERENCE TO RELATED APPLICATION(S)

This application is a continuation of PCT application No. PCT/CN2017/101466, filed on Sep. 12, 2017, which claims priority to Chinese Patent Application No. 201611143072.7, filed on Dec. 7, 2016, the disclosures of both of which are hereby incorporated by reference in their entireties.

### TECHNICAL FIELD

The present disclosure relates to the field of Internet technology, and more particularly to a method for wireless fidelity (Wi-Fi®) network scanning and a terminal device.

### BACKGROUND

With the rapid development of information technology, terminal devices (such as mobile phones, tablets, etc.) are widely used. The performance of the terminal devices required by users is becoming higher and higher, not only high processing speed is required, but also high requirement for a function of the terminal devices that can be connected to a Wi-Fi network is made by the users. Experience related to the Wi-Fi network increasingly attracts user's attention. The function of the terminal devices that can be connected to the Wi-Fi network is also widely used, and is an indispensable function of the terminal devices.

Presently, the terminal devices are desired to be not prone to be disconnected from an access point, and also desired to be quickly reconnected to a router after being disconnected from one access point.

### SUMMARY

A method for Wi-Fi network scanning, a terminal device, and a non-transitory computer-readable storage medium are provided according to embodiments of the present disclosure.

According to a first aspect of the embodiments of the present disclosure, a method for Wi-Fi network scanning is provided. The method includes the following. It is determined whether a beacon frame is received from an access point after a terminal device is disconnected from a Wi-Fi network. Wi-Fi network scanning is executed based on a determination that the beacon frame is received from the access point.

According to a second aspect of the embodiments of the present disclosure, a terminal device is provided. The terminal device includes at least one processor and a computer readable memory, coupled to the at least one processor and storing at least one computer executable instruction therein, which when executed by the at least one processor, causes the at least one processor to carry out the following actions. It is determined whether a beacon frame is received from an access point after the terminal device is disconnected from a Wi-Fi network. Wi-Fi network scanning is executed based on a determination that the beacon frame is received from the access point.

According to a third aspect, a non-transitory computer-readable storage medium is provided. The storage medium stores at least one computer program which, when executed by at least one processor, causes the at least one processor to carry out the following actions. It is determined whether a beacon frame is received from an access point after a terminal device is disconnected from a Wi-Fi network. Wi-Fi network scanning is executed based on a determination that the beacon frame is received from the access point.

### BRIEF DESCRIPTION OF DRAWINGS

To describe technical solutions in embodiments of the present disclosure more clearly, the following briefly introduces the accompanying drawings required for describing the embodiments. Apparently, the accompanying drawings in the following description merely illustrate some embodiments of the present disclosure. Those of ordinary skill in the art may also obtain other drawings based on these accompanying drawings without creative efforts.

FIG. 1 is a flow chart illustrating a method for wireless fidelity (Wi-Fi) network scanning according to a first embodiment of the present disclosure.

FIG. 2 is a schematic diagram illustrating a Wi-Fi network list according to an embodiment of the present disclosure.

FIG. 3 is a flow chart illustrating a method for Wi-Fi network scanning according to a second embodiment of the present disclosure.

FIG. 4 is a block diagram illustrating a device for Wi-Fi network scanning according to an embodiment of the present disclosure.

FIG. 5 is a block diagram illustrating an executing unit of the device illustrated in FIG. 4 according to an embodiment of the present disclosure.

FIG. 6 is a block diagram illustrating the executing unit illustrated in FIG. 4 according to an embodiment of the present disclosure.

FIG. 7 is a block diagram illustrating a selecting module of the executing unit illustrated in FIG. 4 according to an embodiment of the present disclosure.

FIG. 8 is a block diagram illustrating a modification of the device illustrated in FIG. 4 according to an embodiment of the present disclosure.

FIG. 9 is a block diagram illustrating a terminal device according to an embodiment of the present disclosure.

### DETAILED DESCRIPTION

Technical solutions embodied by the embodiments of the present disclosure will be described in a clear and comprehensive manner in reference to the accompanying drawings intended for the embodiments. It is evident that the embodiments described herein constitute merely some rather than all of the embodiments of the present disclosure. Those of ordinary skill in the art is able to derive other embodiments based on these embodiments without making inventive efforts, which all such derived embodiments shall all fall in the protection scope of the present disclosure.

“Terminal device” in the embodiments of the present disclosure may include smart phones (such as Android® phones, iOS® phones, Windows Phones, etc.), tablet PCs, palmtops, laptops, mobile Internet devices (MID), wearable devices, or the like. The above-mentioned terminal devices are merely illustrative and not exhaustive, including but not limited to the above-described terminal devices.

Generally, when a user moves away a coverage area of an access point, a terminal device is disconnected from the access point. When the terminal device returns to the coverage area of the access point, the terminal device fails to be connected to the access point quickly. The main reason is generally that a Wi-Fi chip of the terminal device usually executes Wi-Fi network scanning once each time interval (e.g., 30 seconds). After executing the Wi-Fi network scanning once, if the terminal device still fails to be connected to a Wi-Fi network, the terminal device needs to wait the time interval before next Wi-Fi network scanning. Therefore, how to improve efficiency of the Wi-Fi network scanning needs to be solved. In embodiments of the present disclosure, a method and a terminal device are provided, which can improve the efficiency of the Wi-Fi network scanning.

In one implementation, it is assumed that the terminal device is connected to an access point A, when the terminal device is not within a coverage area of the access point A, beacon timeout happens. That is, when failing to receive a beacon frame from the access point A for a certain time, the terminal device determines that the terminal device is beyond the coverage area of the access point A, and is disconnected from the Wi-Fi network. Currently, the terminal device is disconnected from the Wi-Fi network as follows.

Firstly, after being disconnected from the Wi-Fi network, the terminal device executes Wi-Fi network scanning each the time interval, for example, executes the Wi-Fi network scanning once each 30 seconds. Since power consumption of the terminal device increases when executing the Wi-Fi network scanning frequently, the terminal device is set to not execute the Wi-Fi network scanning frequently.

Secondly, after scanning the Wi-Fi network, a result of the Wi-Fi network scanning (i.e., a Wi-Fi network list) is reported to an operating system of the terminal device. The system can determine, according to a history connection record, whether there is an access point to which the terminal device was successfully connected to, for example, the terminal device was previously connected to the access point A.

Finally, a communication connection between the access point A and the terminal device is established.

In the above-mentioned process, the terminal device executes the Wi-Fi network scanning once each time interval, thus after being disconnected from one access point, even if the beacon frame is received before elapse of the time interval (generally, the beacon frame is transmitted more frequently than the Wi-Fi network scanning is executed), a Wi-Fi network scan mode fails to be initiated, that is, the Wi-Fi network scanning is not executed immediately after the terminal device enters the coverage area of one access point, thereby reducing the efficiency of the Wi-Fi network scanning.

When the terminal device is disconnected from the Wi-Fi network, the Wi-Fi network scanning is executed as follows.

After the terminal device is disconnected from the Wi-Fi network, the terminal device, generally the Wi-Fi chip of the terminal device, determines whether a beacon frame is received from an access point.

When the Wi-Fi chip of the terminal device receives the beacon frame from the access point, the Wi-Fi chip initiates the Wi-Fi network scan mode to execute the Wi-Fi network scanning.

Once the terminal device receives the beacon frame, the Wi-Fi network scan mode is initiated, thereby improving the efficiency of the Wi-Fi network scanning.

In a first aspect of the present disclosure, a method for Wi-Fi network scanning is provided. The method includes the following. It is determined whether a beacon frame is received from an access point after a terminal device is disconnected from a Wi-Fi network. Wi-Fi network scanning is executed based on a determination that the beacon frame is received from the access point.

In one implementation, the Wi-Fi network scanning is executed as follows.

Information of the access point that transmits the beacon frame is acquired, and Wi-Fi network scanning is executed according to the information of the access point.

In one implementation, the Wi-Fi network scanning is executed as follows. At least one history scan record of the terminal device is acquired. The at least one history scan record contains information of M access points, where the M access points includes the access point that transmits the beacon frame, and M is an integer larger than one. Information of N access points from the information of the M access points is selected, where N is a positive integer smaller than or equal to M. The Wi-Fi network scanning is executed according to the information of the N access points.

In one implementation, the information of the N access points from the information of the M access points is selected as follows. Stability of each one of the M access points is evaluated according to the information of the M access points to acquire M stability evaluation values. The information of the N access points is acquired by acquiring information of access points corresponding to N stability evaluation values of the M stability evaluation values, where each one of the N stability evaluation values being larger than a preset stability threshold.

In one implementation, the stability of each one of the M access points according to the information of the M access points is evaluated as follows. Multiple stability evaluation index sets are acquired by extracting stability evaluation indexes from the information of the M access points. The stability of each one of the M access points is evaluated according to the stability evaluation index sets.

In one implementation, the stability evaluation indexes for each access point includes at least one of: the number of access users of each access point, a signal strength value of each access point, a network rate of each access point, and a network bandwidth of each access point.

In one implementation, the Wi-Fi network scanning is executed as follows. The Wi-Fi network scanning is executed to scan the access point that transmits the beacon frame. A password is input automatically and the terminal device is connected to the access point according to the password when the access point is scanned, where the password is stored in the terminal device.

In a second aspect, a terminal device is provided. The terminal device includes at least one processor and a computer readable memory, coupled to the at least one processor and storing at least one computer executable instruction therein, which when executed by the at least one processor, causes the at least one processor to carry out the following actions. It is determined whether a beacon frame is received from an access point after the terminal device is disconnected from a Wi-Fi network. Wi-Fi network scanning is executed based on a determination that the beacon frame is received from the access point.

In a third aspect of the present disclosure, a non-transitory computer-readable storage medium is provided. The storage medium stores at least one computer program which, when executed by at least one processor, causes the at least one processor to carry out the following actions. It is determined whether a beacon frame is received from an access point after a terminal device is disconnected from a Wi-Fi network. Wi-Fi network scanning is executed based on a determination that the beacon frame is received from the access point.

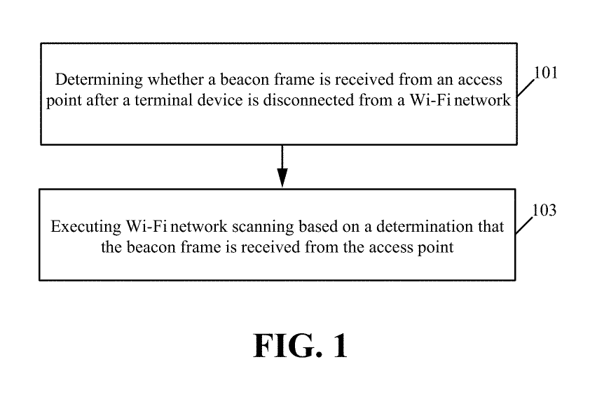

FIG. 1 is a flow chart illustrating a method for Wi-Fi network scanning according to a first embodiment of the present disclosure. In this embodiment, the method begins at block 101.

At block 101, after a terminal device is disconnected from a Wi-Fi network, the terminal device determines whether a beacon frame is received from an access point.

A communication connection between the terminal device and the access point has been established prior to the operation at block 101, and the terminal device is disconnected from the access point at block 101. What needs to be illustrated is that the terminal device still has the function of executing Wi-Fi network scanning once each time interval, thus if the terminal device fails to receive the beacon frame for a certain time (longer than the time interval), the terminal device still can execute the Wi-Fi network scanning. Therefore, one thread can be adopted to determine whether the beacon frame is received, and another thread can be further adopted to execute the Wi-Fi network scanning once each time interval. In one implementation, one access point can broadcast the beacon frame each another time interval shorter than the time interval for the Wi-Fi network scanning, and only terminal devices within the coverage area of the access point can receive the beacon frame. The time interval for the Wi-Fi network scanning may be set by the system of the terminal device by default, or may be set by the user. Generally, the time interval for the Wi-Fi network scanning cannot be set to be large, because the larger the number of times of executing the Wi-Fi network scanning is, the greater the power consumption of the terminal device is.

At block 103, when the beacon frame is received from the access point, the terminal device executes the Wi-Fi network scanning.

When the terminal device receives the beacon frame, the terminal device immediately executes the Wi-Fi network scanning. That is, the Wi-Fi network scan mode is initiated immediately to execute the Wi-Fi network scanning without waiting for one complete scan cycle.

For example, it is assumed that the Wi-Fi network scanning is executed once each 30 seconds, and the beacon frame from the target access point is broadcast once each second. In the related art, after executing the Wi-Fi network scanning once, the Wi-Fi network scanning is re-executed upon elapse of a scan interval of 30 seconds. However, in this implementation, when the beacon frame is detected by the terminal device within the scan interval of 30 seconds, the Wi-Fi network scanning is executed directly without waiting for the complete scan cycle of 30 seconds. In this way, the access point that transmits the beacon frame can be quickly scanned, such that the terminal device can be connected to the access point conveniently and quickly.

In short, when the terminal device is within the coverage area of the access point A, and the communication connection between the terminal device and the access point A is established, after the terminal device is beyond the coverage area of the access point A, the terminal device is disconnected from the access point A. When the terminal device re-enters the coverage area of the access point A, the beacon frame can be received, thus the terminal device executes the Wi-Fi network scanning immediately after receiving the beacon frame.

In one implementation, the Wi-Fi network scanning is executed as follows.

Information of the access point that transmits the beacon frame is acquired, and the Wi-Fi network scanning is executed according to the information of the access point.

The terminal device can directly determine the access point that transmits the beacon frame and the information of the access point, and execute the Wi-Fi network scanning according to the information of the access point. In this way, it does not need to scan other access points, thereby increasing a speed of the Wi-Fi network scanning.

In one implementation, the Wi-Fi network scanning is executed as follows.

Operation B1, at least one history scan record of the terminal device is acquired, the at least one history scan record contains information of M access points, where the M access points includes the access point that transmits the beacon frame, and M is an integer larger than one.

Operation B2, information of N access points is selected from the information of the M access points, where N is a positive integer smaller than or equal to M.

Operation B3, the Wi-Fi network scanning is executed according to the information of the N access points.

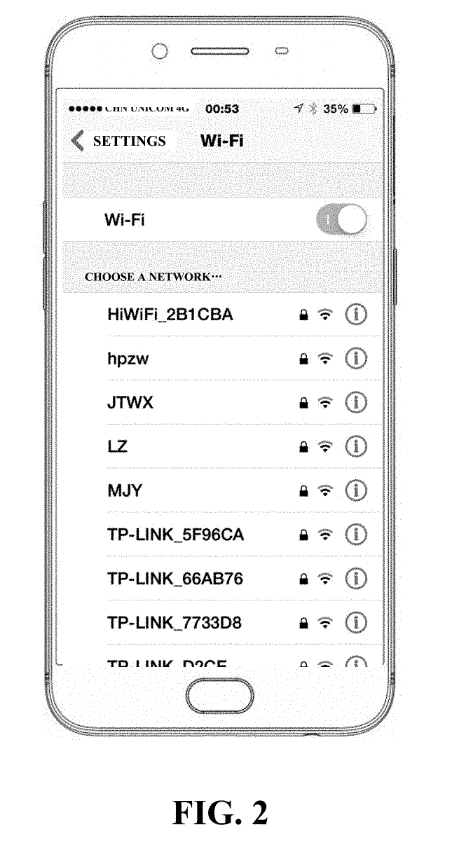

The terminal device can generate one scan record (e.g., the Wi-Fi network list illustrated in FIG. 2) after executing the Wi-Fi network scanning once. The scan record can contain multiple access points and information of the multiple access points. In the operation B1, the terminal device can acquire the history scan record acquired at a time closest to the current time and containing the information of the access point that transmits the beacon frame. Assuming that the history scan record contains the information of the M access points, the information of the N access points may be selected from the information of the M access points. Since the information of the M access points may contain information of some access points having low security, information of some access points encrypted with dynamic passwords, or information of some unstable access points, etc., it needs to exclude the information of the access points with the above-mentioned situations from the information of the M access points, such that scan speed of the Wi-Fi chip can be improved. When an access point is scanned, the Wi-Fi chip needs to determine signal strength and stability of the access point, which consumes power and time. Thus, in the history scan record, the access points encrypted with dynamic passwords, the access points having low security, or the unstable access points can be directly marked, such that access points other than the access points marked can be directly scanned, thereby executing the Wi-Fi network scanning according to the information of the N access points.

In one implementation, in the operation B2, the information of the N access points is selected from the information of the M access points as follows.

Operation B21, stability of each one of the M access points is evaluated according to the information of the M access points to acquire M stability evaluation values.

Operation B22, information of access points corresponding to N stability evaluation values of the M stability evaluation values is acquired, where each one of the N stability evaluation values is larger than a preset stability threshold.

In the operation B21, the stability evaluation value of each one of the M access points can be determined, and the stability evaluation value of each one of the M access points is adopted to evaluate the stability of each one of the M access points. The larger the stability evaluation value of one access point is, the higher the stability of the access point is. The preset stability threshold may be set by the system of the terminal device by default, or may be set by the user. After determining the stability evaluation value of each one of the M access points, the terminal device may further acquire the information of the access points corresponding to the N stability evaluation values of the M stability evaluation values, where each one of the N stability evaluation values is larger than the preset stability threshold.

In one implementation, in the operation B21, according to the information of the M access points, the stability of each one of the M access points is evaluated as follows.

Operation B211, Multiple stability evaluation index sets are acquired by extracting stability evaluation indexes from the information of the M access points.

Operation B212, the stability of each one of the M access points is evaluated according to the stability evaluation index sets.

Each one of the above-mentioned stability evaluation index sets contains at least one stability evaluation index. In one implementation, at least one stability evaluation index may be adopted to evaluate the stability of each access point to obtain the stability evaluation value of each access point. The at least one stability evaluation index for each access point may include, but is not limited to, the number of access users of each access point, a signal strength value of each access point, a network rate of each access point, and a network bandwidth of each access point, or the like.

It is to be noted that since certain limitations may be introduced by evaluating the stability of each access point according to one stability evaluation index, multiple stability evaluation indexes can be adopted to evaluate the stability of each access point. Certainly, it may not be good to adopt many stability evaluation indexes to evaluate the stability of each access point, because the more stability evaluation indexes are, the higher computational complexity of the stability evaluation is, and stability evaluation effect may not be good. Therefore, in the case that requirement for the stability evaluation is high, multiple stability evaluation indexes ranging from two to ten may be adopted to evaluate the stability of each access point. In one implementation, the number of stability evaluation indexes and the selection of indexes may be determined according to specific implementation conditions.

In one implementation, in the case that requirement for accuracy of the stability evaluation of each access point is high, multiple stability evaluation indexes may be adopted to evaluate the stability of each access point. When evaluating the stability of each access point according to the multiple stability evaluation indexes, a weight of each one of the multiple stability evaluation indexes is set to acquire multiple stability evaluation values, and a final stability evaluation value can be acquired according to the multiple stability evaluation values and the corresponding weights. For example, three stability evaluation indexes, i.e., an index A, an index B, and an index C are adopted. A weight of the index A is a1, a weight of the index B is a2, and a weight of the index C is a3. When the stability of one access point is evaluated with the index A, the index B, and the index C, a stability evaluation value corresponding to the index A is b1, a stability evaluation value corresponding to the index B is b2, and a stability evaluation value corresponding to the index C is b3. The final stability evaluation value equals to a sum of a1 multiplied by b1, a2 multiplied by b2, and a3 multiplied by b3. Generally, the larger the stability evaluation value is, the higher the stability of the access point is.

In one implementation, the method may further include the following after the operation at block 103.

When the access point that transmits the beacon frame is scanned by the terminal device, a password for connecting to the access point is input automatically, and the terminal device is connected to the access point according to the password. The terminal device stores the password if the terminal device was previously connected to the access point.

In the implementation, when the access point is scanned by the terminal device in the Wi-Fi network scanning, the password can be automatically input, whereby the terminal device can be quickly connected to the target access point.

It can be seen that in the implementations of the present disclosure, after the terminal device was disconnected from the target access point, the terminal device determines whether the beacon frame is received. When the beacon frame is received, the Wi-Fi network scanning is executed. Thus, after being disconnected from the Wi-Fi network, when the beacon frame is received, the Wi-Fi network scanning is immediately executed without waiting for a finish of one complete scan cycle. In this way, the Wi-Fi network scanning can be quickly initiated, thereby improving the efficiency of the Wi-Fi network scanning.

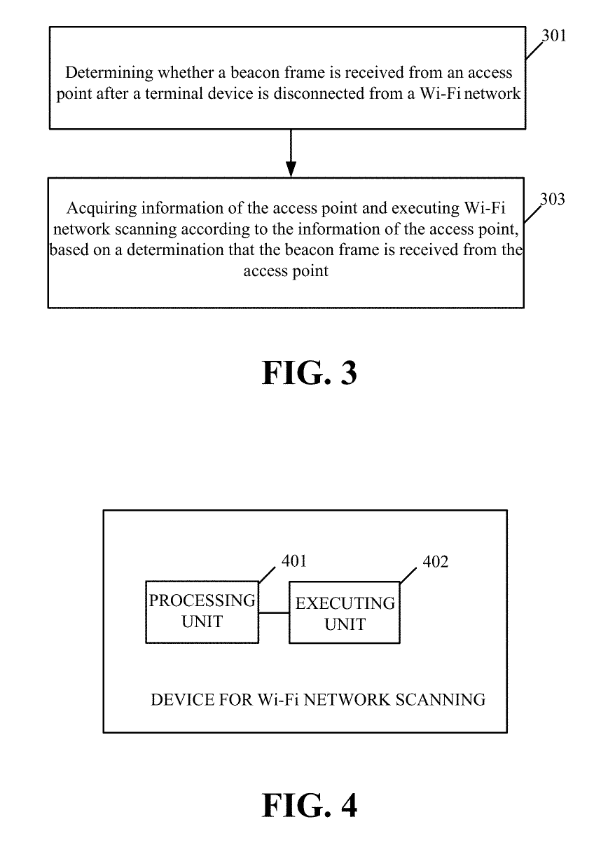

Consistent with the above embodiment, FIG. 3 is a flow chart illustrating a method for Wi-Fi network scanning according to a second embodiment of the present disclosure. In this embodiment, the method begins at block 301.

At block 301, after a terminal device was disconnected from a Wi-Fi network, the terminal device determines whether a beacon frame is received from an access point.

At block 303, based on a determination that the terminal device receives the beacon frame from the access point, the terminal device acquires information of the access point, and executes the Wi-Fi network scanning according to the information of the access point.

In one implementation, the beacon frame from the access point may carry a hardware address of the access point. When the terminal device receives the beacon frame from the access point, the Wi-Fi network scanning can be executed according to the hardware address. Since just scanning the access point is executed, and other access points need not to be scanned, the scan speed can be improved.

It can be seen that in the embodiment of the present disclosure, after the terminal device is disconnected from the access point, the terminal device determines whether the beacon frame is received from the access point. When the beacon frame is received from the access point, the terminal device executes the Wi-Fi network scanning. Thus, after being disconnected from the Wi-Fi network, when the beacon frame is received from the access point, the Wi-Fi network scanning is executed without waiting for a finish of one complete scan cycle. In this way, the Wi-Fi network scanning can be quickly initiated, thereby improving the efficiency of the Wi-Fi network scanning.

Consistent with the above embodiments, a device for implementing the above-mentioned method for Wi-Fi scanning is described as follows.

FIG. 4 is a block diagram illustrating the device for Wi-Fi network scanning according to an embodiment of the present disclosure. The device includes a processing unit 401 and an executing unit 402.

The processing unit 401 is configured to determine whether a beacon frame is received from an access point after the terminal device is disconnected from a Wi-Fi network.

The executing unit 402 is configured to execute Wi-Fi network scanning when the beacon frame is received from the access point.

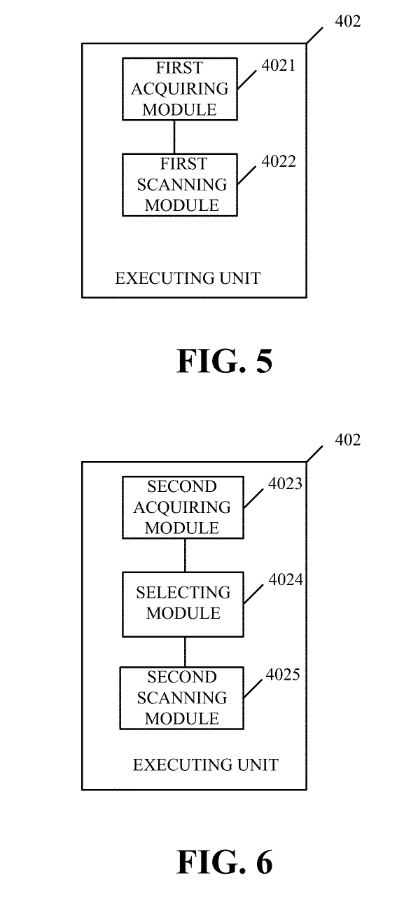

In one implementation, FIG. 5 is a detail block diagram illustrating the executing unit 402 of the device illustrated in FIG. 4. The executing unit 402 includes a first acquiring module 4021 and a first scanning module 4022.

The first acquiring module 4021 is configured to acquire information of the access point that transmits the beacon frame.

The first scanning module 4022 is configured to execute the Wi-Fi network scanning according to the information the access point.

Furthermore, in one implementation, FIG. 6 is a detail block diagram illustrating the executing unit 402 illustrated in FIG. 4. The executing unit 402 includes a second acquiring module 4023, a selecting module 4024, and a second scanning module 4025.

The second acquiring module 4023 is configured to acquire at least one history scan record of the terminal device, the at least one scan record contains information of M access points, where the M access points includes the access point that transmits the beacon frame, and M is an integer larger than one.

The selecting module 4024 is configured to select information of N access points from the information of the M access points, where N is a positive integer smaller than or equal to M.

The second scanning module 4025 is configured to execute the Wi-Fi network scanning according to the information of the N access points.

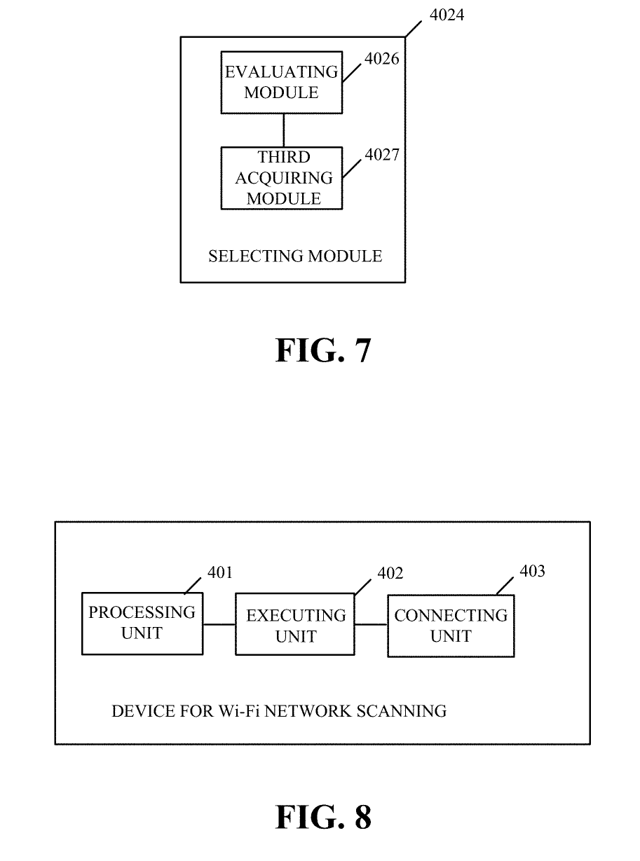

Furthermore, in one implementation, FIG. 7 is a detail block diagram illustrating the selecting module 4024 illustrated in FIG. 6. The selecting module 4024 includes an evaluating module 4026 and a third acquiring module 4027.

The evaluating module 4026 is configured to evaluate stability of each one of the M access points according to the information of the M access points to acquire M stability evaluation values.

The third acquiring module 4027 is configured to acquire the information of the N access points by acquiring information of access points corresponding to N stability evaluation values of the M stability evaluation values, where each one of the N stability evaluation values is larger than a preset stability threshold.

In one implementation, FIG. 8 is a block diagram illustrating a modification of the device illustrated in FIG. 4. Compared with FIG. 4, the device in FIG. 8 further includes a connecting unit 403.

The connecting unit 403 is configured to input a password for connecting to the access point automatically and to connect the terminal device to the access point according to the password, when the access point is scanned by the terminal device, where the password is stored in the terminal device.

It can be seen that, by means of the device for the Wi-Fi network scanning provided by the embodiment of the present disclosure, after the terminal device is disconnected from the Wi-Fi network, whether the beacon frame is received from the access point is determined. When the beacon frame is received from the access point, the Wi-Fi network scanning is executed. Thus, after being disconnected from the Wi-Fi network, when the beacon frame is received from the access point, the Wi-Fi network scanning is immediately executed without waiting for a finish of one complete scan cycle. In this way, the Wi-Fi network scanning can be quickly initiated, thereby improving the efficiency of the Wi-Fi network scanning.

It should be noted that, the devices for the Wi-Fi network scanning described in the embodiments of the present disclosure are presented in the form of functional units. The term “unit” used herein should be understood as the broadest meaning as possible, and an object for achieving functions defined by each “unit” may be, for example, an application-specific integrated circuit (ASIC), a single circuit, a processor (shared, dedicated, or chipset) and a memory for executing one or more software or firmware programs, a combinational logic circuit, and/or other suitable components that can achieve the above described functions.

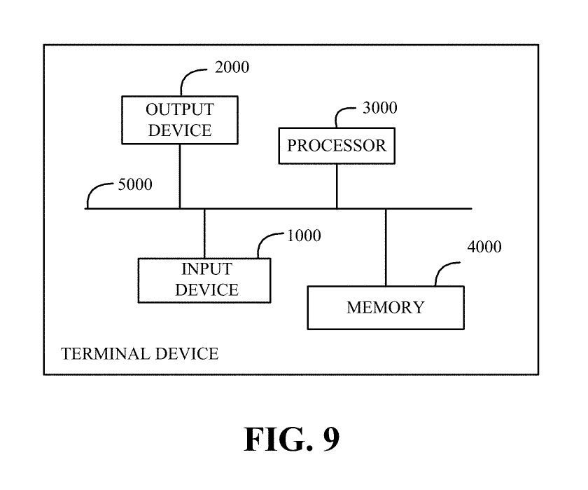

As an example, after the terminal device is disconnected from the Wi-Fi network, the processing unit 401 configured to monitor whether the beacon frame is received from the access point can be implemented by a terminal device illustrated in FIG. 9. In an implementation, the terminal device may invoke executable program codes in a memory 4000 through a processor 3000 to determine whether the beacon frame is received from the access point after the terminal device is disconnected from the Wi-Fi network.

Consistent with the above embodiments, FIG. 9 is a block diagram illustrating a terminal device according to an embodiment of the present disclosure. As illustrated in FIG. 9, the terminal device includes at least one input device 1000, at least one output device 2000, at least one processor 3000 (such as a CPU), and a memory 4000. The input device 1000, the output device 2000, the processor 3000, and the memory 4000 are coupled with each other via a bus 5000.

In one implementation, the at least one input device 1000 may be a touch panel, a physical button, a mouse, or the like.

In one implementation, the at least one output device 2000 may be a display screen.

In one implementation, the memory 4000 may be a high speed RAM memory, or may be a non-volatile memory such as a disk memory. The memory 4000 is configured to store a set of program codes. The input device 1000, the output device 2000, and the processor 3000 are configured to invoke the program codes stored in the memory 4000 to carry out the following.

The processor 3000 is configured to determine whether a beacon frame is received from an access point after the terminal device is disconnected from a Wi-Fi network, and to execute Wi-Fi network scanning when the beacon frame is received from the access point.

In one implementation, the processor 3000 configured to execute the Wi-Fi network scanning is configured to acquire information of the access point that transmits the beacon frame, and to execute the Wi-Fi network scanning according to the information of the access point.

In one implementation, the processor 3000 configured to execute the Wi-Fi network scanning is configured to acquire at least one scan record, the at least one scan record contains information of M access points, where the M access points includes the access point that transmits the beacon frame, and M is an integer larger than one. The processor 3000 is further configured to select information of N access points from the information of the M access points, where N is a positive integer smaller than or equal to M. The processor 3000 is further configured to execute the Wi-Fi Network® scanning according to the information of the N access points.

In one implementation, the processor 3000 configured to select the information of N access points from the information of the M access points is configured to evaluate stability of each one of the M access points according to the information of the M access points to acquire M stability evaluation values, and to acquire the information of the N access points by acquiring information of access points corresponding to N stability evaluation values of the M stability evaluation values, where each one of the N stability evaluation values is larger than a preset stability threshold.

In one implementation, the processor 3000 configured to evaluate the stability of each one of the M access points according to the information of the M access points is configured to acquire multiple stability evaluation index sets by extracting stability evaluation indexes from the information of the M access points, and to evaluate the stability of each one of the access points according to the M stability evaluation index sets.

In one implementation, the stability evaluation index for each access point includes at least one of: the number of access users of each access point, a signal strength value of each access point, a network rate of each access point, and a network bandwidth of each access point.

In one implementation, when the access point is scanned by the terminal device, the processor 3000 is further configured to input a password for connecting to the access point automatically and to connect the terminal device to the access point according to the password, where the password is stored in the terminal device.

Embodiments of the present disclosure further provide a computer storage medium. The computer storage medium is configured to store programs which, when executed, are operable to implement part or all of operations of the methods for executing Wi-Fi network scanning described in the foregoing method embodiments.

Embodiments of the present disclosure further provide a computer program product. The computer program product includes a non-transitory computer readable storage medium configured to store computer programs. The computer programs are operable with a computer to implement part or all of operations of the methods for executing Wi-Fi network scanning described in the foregoing method embodiments.

Although the present disclosure has been described herein in combination with various embodiments of the present disclosure, in the process of implementing the present disclosure seeking for protection, those skilled in the art will understand and achieve other embodiments based on the specification, the claims, and the accompanying drawings of the present disclosure as viewed. The term “comprising” in the claims does not exclude other components or steps. In addition, the term “a/an” or “one” does not exclude a plurality of components or steps. A single processor or other units may fulfill several functions described in the claims. Certain technical features are described in different dependent claims, however, a possible combination of these technical features can be made to achieve a good effect.

Those skilled in the art will appreciate that embodiments of the present disclosure can be provided as a method, an apparatus (device), or a computer program product. Accordingly, the above embodiments of present disclosure may be implemented through hardware, software, or any other combination thereof. In addition, the present disclosure may take the form of a computer program product embodied on one or more computer readable storage medium (including but not limited to a disk memory, a CD-ROM, an optical memory, etc.) including computer readable program codes. Computer programs are stored or distributed in a suitable medium, and are provided together with other hardware or are as part of certain hardware, or are distributed in other forms, such as an Internet-based form, other wired or wireless telecommunication-system-based form, or the like.

The present disclosure has been described with reference to flow charts and/or block diagrams of the methods, apparatuses (devices), and computer program products of the embodiments of the present disclosure. It will be understood that computer program instructions are operable to implement each procedure of the flow charts and/or each block of the block diagrams, and to implement a combination thereof. These computer program instructions can be provided for a processor of a general-purpose computer, a special-purpose computer, an embedded processor, or other programmable data processing devices to produce an equipment, to enable instructions executed by a processor of a computer or other programmable data processing devices to produce a device for implementing functions specified in one or more procedures of the flow charts or one or more blocks of the block diagrams.

These computer program instructions can also be stored in a computer readable memory that can direct a computer or other programmable data processing devices to operate in a certain manner, to enable instructions stored in the computer readable memory to produce an article of manufacture including an instruction device for implementing functions specified in one or more procedures of the flow charts or one or more blocks of the block diagrams.

These computer program instructions can also be loaded into a computer or other programmable data processing devices, to enable a computer or other programmable devices to execute a series of operational steps to achieve computer processing, such that instructions executed on a computer or other programmable devices can provide steps for implementing functions specified in one or more procedures of the flow charts or one or more blocks of the block diagrams.

While the present disclosure has been described with respect to the specific features and embodiments thereof, it should be understood that various modifications and combinations can be made herein without departing from the spirit and scope of the present disclosure. Accordingly, the specification and the accompanying drawings are merely illustrative illustration of the present disclosure as defined by the claims attached, and can be regarded as covering any and all modifications, variations, combinations or equivalents within the scope of the present disclosure. It will be apparent that those skilled in the art can make various modifications and variations to the present disclosure without departing from the spirit and scope of the present disclosure. Thus, it is intended that the present disclosure covers such modifications and variations thereof on the basis of such modifications and variations falling within the scope of the claims and the equivalents thereof.

What is claimed is:

1. A method for wireless fidelity (Wi-Fi) network scanning, comprising:
determining whether a beacon frame is received from an access point after a terminal device is disconnected from a Wi-Fi network; and
executing Wi-Fi network scanning, based on a determination that the beacon frame is received from the access point.

2. The method of claim 1, wherein executing the Wi-Fi network scanning comprises:
acquiring information of the access point; and
executing the Wi-Fi network scanning according to the information of the access point.

3. The method of claim 1, wherein executing the Wi-Fi network scanning comprises:
acquiring at least one history scan record of the terminal device, the at least one history scan record containing information of M access points, the M access points comprising the access point that transmits the beacon frame, and M being an integer larger than one;
selecting information of N access points from the information of the M access points, N being a positive integer smaller than or equal to M; and
executing the Wi-Fi network scanning according to the information of the N access points.

4. The method of claim 3, wherein selecting the information of the N access points from the information of the M access points comprises:
evaluating stability of each one of the M access points according to the information of the M access points to acquire M stability evaluation values; and
acquiring the information of the N access points by acquiring information of access points corresponding to N stability evaluation values of the M stability evaluation values, each one of the N stability evaluation values being larger than a preset stability threshold.

5. The method of claim 4, wherein evaluating the stability of each one of the M access points according to the information of the M access points comprises:
acquiring a plurality of stability evaluation index sets by extracting stability evaluation indexes from the information of the M access points; and
evaluating the stability of each one of the M access points according to the plurality of stability evaluation index sets.

6. The method of claim 5, wherein the stability evaluation indexes for each access point comprise at least one of: a number of access users of each access point, a signal strength value of each access point, a network rate of each access point, and a network bandwidth of each access point.

7. The method of claim 1, wherein executing the Wi-Fi network scanning further comprises:
executing the Wi-Fi network scanning to scan the access point that transmits the beacon frame; and
inputting a password for connecting to the access point automatically and connecting the terminal device to the access point according to the password when the access point is scanned, the password being stored in the terminal device.

8. A terminal device comprising:
at least one processor; and
a computer readable memory, coupled to the at least one processor and storing at least one computer executable instruction therein, which when executed by the at least one processor, causes the at least one processor to carry out actions, comprising:
determining whether a beacon frame is received from an access point after the terminal device is disconnected from a Wi-Fi network; and
executing Wi-Fi network scanning based a determination that the beacon frame is received from the access point.

9. The terminal device of claim 8, wherein the at least one processor carrying out the action of executing the Wi-Fi network scanning is caused to carry out actions, comprising:
acquiring information of the access point; and
executing the Wi-Fi network scanning according to the information of the access point.

10. The terminal device of claim 8, wherein the at least one processor carrying out the action of executing the Wi-Fi network scanning is caused to carry out actions, comprising:
acquiring at least one history scan record of the terminal device, the at least one history scan record containing information of M access points, the M access points comprising the access point that transmits the beacon frame, and M being an integer larger than one;
selecting information of N access points from the information of the M access points, N being a positive integer smaller than or equal to M; and
executing the Wi-Fi network scanning according to the information of the N access points.

11. The terminal device of claim 10, wherein the at least one processor carrying out the action of selecting the information of the N access points from the information of the M access points is caused to carry out actions, comprising:
evaluating stability of each one of the M access points according to the information of the M access points to acquire M stability evaluation values; and
acquiring the information of the N access points by acquiring information of access points corresponding to N stability evaluation values of the M stability evaluation values, each one of the N stability evaluation values being larger than a preset stability threshold.

12. The terminal device of claim 11, wherein the at least one processor carrying out the action of evaluating the stability of each one of the M access points according to the information of the M access points is caused to carry out actions, comprising:
acquiring a plurality of stability evaluation index sets by extracting stability evaluation indexes from the information of the M access points; and
evaluating the stability of each one of the M access points according to the plurality of stability evaluation index sets.

13. The terminal device of claim 12, wherein the stability evaluation indexes for each access point comprise at least one of: a number of access users of each access point, a signal strength value of each access point, a network rate of each access point, and a network bandwidth of each access point.

14. The terminal device of claim 8, wherein the at least one processor carrying out the action of executing the Wi-Fi network scanning is caused to carry out actions, further comprising:
executing the Wi-Fi network scanning to scan the access point that transmits the beacon frame; and
inputting a password for connecting to the access point automatically and connecting the terminal device to the access point according to the password when the access point is scanned, the password being stored in the terminal device.

15. A non-transitory computer-readable storage medium storing at least one computer program which, when executed by at least one processor, causes the at least one processor to carry out actions, comprising:
determining whether a beacon frame is received from an access point after a terminal device is disconnected from a Wi-Fi network; and
executing Wi-Fi network scanning based a determination that the beacon frame is received from the access point.

16. The non-transitory computer-readable storage medium of claim 15, wherein the at least one computer program executed by the processor to carry out the action of executing the Wi-Fi network scanning is executed by the at least one processor to carry out actions, comprising:
acquiring information of the access point; and
executing the Wi-Fi network scanning according to the information of the access point.

17. The non-transitory computer-readable storage medium of claim 15, wherein the at least one computer program executed by the processor to carry out the action of executing the Wi-Fi network scanning is executed by the at least one processor to carry out actions, comprising:
acquiring at least one history scan record of the terminal device, the at least one history scan record containing information of M access points, the M access points comprising the access point that transmits the beacon frame, and M being an integer larger than one;
selecting information of N access points from the information of the M access points, N being a positive integer smaller than or equal to M; and
executing the Wi-Fi network scanning according to the information of the N access points.

18. The non-transitory computer-readable storage medium of claim 17, wherein the at least one computer program executed by the processor to carry out the action of selecting the information of the N access points from the information of the M access points is executed by the at least one processor to carry out actions, comprising:
evaluating stability of each one of the M access points according to the information of the M access points to acquire M stability evaluation values; and
acquiring the information of the N access points by acquiring information of access points corresponding to N stability evaluation values of the M stability evaluation values, each one of the N stability evaluation values being larger than a preset stability threshold.

19. The non-transitory computer-readable storage medium of claim 18, wherein the at least one computer program executed by the processor to carry out the action of evaluating the stability of each one of the M access points according to the information of the M access points is executed by the at least one processor to carry out actions, comprising:
acquiring a plurality of stability evaluation index sets by extracting stability evaluation indexes from the information of the M access points; and
evaluating the stability of each one of the M access points according to the plurality of stability evaluation index sets.

20. The non-transitory computer-readable storage medium of claim 15, wherein the at least one computer program executed by the processor to carry out the action of executing the Wi-Fi network scanning is executed by the at least one processor to carry out actions, further comprising:
executing the Wi-Fi network scanning to scan the access point that transmits the beacon frame; and
inputting a password for connecting to the access point automatically and connecting the terminal device to the access point according to the password when the access point is scanned, the password being stored in the terminal device.
